(19) United States
(12) Patent Application Publication
(10) Pub. No.: US 2025/0250685 A1
(43) Pub. Date: Aug. 7, 2025

(54) WATER ELECTROLYSIS SYSTEM AND PRODUCTION METHOD OF GAS BY ELECTROLYSIS OF WATER

(71) Applicant: TOYOTA JIDOSHA KABUSHIKI KAISHA, Toyota-shi (JP)

(72) Inventor: Tomohito ENOKI, Toyota-shi (JP)

(73) Assignee: TOYOTA JIDOSHA KABUSHIKI KAISHA, Toyota-shi (JP)

(21) Appl. No.: 18/957,902

(22) Filed: Nov. 25, 2024

(30) Foreign Application Priority Data
Feb. 7, 2024 (JP) 2024-017171

(51) Int. Cl. C25B 1/04; C25B 9/67; C25B 15/08

(52) U.S. Cl. CPC C25B 1/04; C25B 9/67; C25B 15/085

(57) ABSTRACT

The water electrolysis system includes: a first cooling device that cools a gas containing a predetermined gas component generated by electrolysis of water to a first cooling temperature that is higher than or equal to a boiling point of the gas component so that the first impurity having a boiling point higher than the first cooling temperature can be separated; a gas-liquid separation device that separates the first impurity from the gas; and a second cooling device that cools the gas from which the first impurity is separated to a second cooling temperature that is lower than the boiling point of the gas component, and liquefies the gas component so that the second impurity having a boiling point lower than the second cooling temperature can be separated as a gas.

### CROSS-REFERENCE TO RELATED APPLICATION

This application claims priority to Japanese Patent Application No. 2024-017171 filed on Feb. 7, 2024, incorporated herein by reference in its entirety.

### BACKGROUND

### 1. Technical Field

The present specification relates to a water electrolysis system and a production method of gas by electrolysis of water.

### 2. Description of Related Art

This type of water electrolysis system performs electrolysis of water to produce a component gas containing hydrogen or oxygen as a gas component, and supplies the component gas to a fuel cell or the like. In water electrolysis systems, moisture in the component gas is discharged to outside of the system by a dehumidifying device, using a desiccant, cooling by heat exchange with a refrigerant, or the like (Japanese Unexamined Patent Application Publication No. 2023-019061 (JP 2023-019061 A)).

### SUMMARY

Water can be removed from the gas by using a dehumidifier. However, impurities, such as oxygen leaking from an oxygen electrode side to a hydrogen electrode side via an electrolyte membrane of a water electrolysis device, cannot be removed from the hydrogen gas. Further, hydrogen leaking from the hydrogen electrode side to the oxygen electrode side cannot be removed from the oxygen gas.

The present specification provides technology for supplying gas with a high degree of purity by removing impurities in gas containing hydrogen or oxygen that is produced by electrolysis of water.

The technology disclosed in the present specification is embodied in a water electrolysis system.
A water electrolysis system includes
a first cooling device that cools a gas containing a predetermined gas component, generated by electrolysis of water, to a first cooling temperature that is no lower than a boiling point of the gas component, and liquifies a first impurity of which a boiling point is higher than the first cooling temperature, so as to be separable from the gas component,
a gas-liquid separation device that separates the first impurity liquefied by the first cooling device from the gas, and
a second cooling device that cools the gas from which the first impurity is separated to a second cooling temperature that is lower than the boiling point of the gas component, and liquifies the gas component such that a second impurity, of which a boiling point is lower than the second cooling temperature, is separable as a gas.

According to this water electrolysis system, the first cooling device liquefies and separates any first impurity, of which the boiling point is higher than the first cooling temperature, that is present. The second cooling device gasifies and separates any second impurity, of which the boiling point is lower than the second cooling temperature, that is present. The first impurity and the second impurity are removed from the gas, and accordingly a gas containing a predetermined gas component with a high degree of purity can be produced.

For example, when the predetermined gas component is hydrogen, the gas component is cooled to a first cooling temperature that is no lower than the boiling point of hydrogen (−253° C.). Thus, for example, water (boiling point of 100° C.) or oxygen (boiling point of −183° C.) of which the boiling point is higher than the first cooling temperature are liquefied. The liquefied water and oxygen are separated from the hydrogen. The gas from which the water and the oxygen are separated is then cooled to a second cooling temperature that is lower than the boiling point of the hydrogen. Thus, when hydrogen is liquefied and an impurity having a boiling point lower than the second cooling temperature is present, this remains as a gas. The impurity remaining as gas is separated from the liquid hydrogen.

Further, for example, when the predetermined gas component is oxygen, the gas component is cooled to the first cooling temperature no lower than the boiling point of oxygen. Thus, for example, water or the like having a boiling point higher than the first cooling temperature is liquefied. The liquefied water is separated from the oxygen. The gas from which water is separated is then cooled to the second cooling temperature that is lower than the boiling point of the oxygen. Thus, when oxygen is liquefied, and impurities having a boiling point lower than the second cooling temperature, such as hydrogen or the like, are present, this remains as a gas. The hydrogen or the like remaining as a gas is separated from the liquid oxygen.

Further, the technology disclosed in the present specification is embodied in a production method of a liquid material by electrolysis of water.
The production method includes
first cooling, of cooling a gas obtained by electrolysis of water supplied from an electrolysis device, and that contains the liquid material that is gasified, to a first cooling temperature that is no lower than a boiling point of the liquid material, and liquifying a first impurity of which a boiling point is higher than the first cooling temperature,
performing gas-liquid separation of the first impurity from the gas, and
second cooling, of cooling the gas from which the first impurity is separated to a second cooling temperature that is lower than the boiling point of the liquid material, and liquifying the gas component such that a second impurity, of which a boiling point is lower than the second cooling temperature, is separable as a gas.

According to this production method, the first impurity is liquefied and separated from the gas in the first cooling. In the second cooling, the gasified liquid material is liquefied and separated from the gas from which the first impurity has been separated. Thus, the liquid material is produced with a high degree of purity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of an example of a water electrolysis system;

FIG. 2 is a diagram illustrating a process of producing an electrolytic gas by a water electrolysis system;

FIG. 3 is a diagram showing a relationship between a gas component and a cooling temperature during hydrogen gas production;

FIG. 4 is a diagram showing the relation between the gas components and the cooling temperature during the production of the oxygen-gas; and

FIG. 5 is a diagram illustrating an outline of another configuration example of the water electrolysis system.

### DETAILED DESCRIPTION OF EMBODIMENTS

The water electrolysis system disclosed in the present specification (hereinafter, simply referred to as the present system) includes: a first cooling device that cools a gas containing a predetermined gas component generated by electrolysis of water to a first cooling temperature that is equal to or higher than a boiling point of the gas component and separably liquefies a first impurity having a boiling point higher than the first cooling temperature from the gas component; a gas-liquid separation device that separates the first impurity liquefied in the first cooling device from the gas; and a second cooling device that cools the gas from which the first impurity is separated to a second cooling temperature that is lower than the boiling point of the gas component, and liquefies the gas component so that a second impurity having a boiling point lower than the second cooling temperature can be separated as a gas.

In one embodiment of the system, the gas component is hydrogen or oxygen. Hydrogen or oxygen are gas components produced by electrolysis of water, respectively.

In one embodiment of the system, the gas component is hydrogen, the first cooling temperature is at least the boiling point of hydrogen and is lower than the boiling point of oxygen, and the second cooling temperature is lower than the boiling point of hydrogen.

In one embodiment of the system, the gas component is oxygen, the first cooling temperature is a temperature above the boiling point of oxygen, and the second cooling temperature is a temperature below the boiling point of oxygen and above the boiling point of hydrogen.

In an embodiment of the system, the first cooling device includes a first heat exchanger and a cooler for cooling the first heat exchanger, and the second cooling device includes a second heat exchanger and a cooler for cooling the second heat exchanger.

A production method of a liquid material by electrolysis of water disclosed in this specification (hereinafter, simply referred to as the present method) includes a first cooling step of cooling the gas containing the liquefied material, which is an electrolyzed gas supplied from an electrolysis apparatus, to a first cooling temperature equal to or higher than a boiling point of the liquefied material to liquefy a first impurity having a boiling point higher than the first cooling temperature, a step of gas-liquid separation of the first impurity from the gas, and a second cooling step of cooling the gas from which the first impurity is separated to a second cooling temperature lower than the boiling point of the liquefied material to separate a second impurity having a boiling point lower than the second cooling temperature as a gas, and liquefying the gasified liquid material.

The method corresponds to a liquid material in which the gas components already described with respect to the system have been gasified. Various embodiments of the first cooling temperature and the second cooling temperature described above with respect to the present system can also be applied to the present method. The system can also be used to produce liquid materials by electrolysis of water.

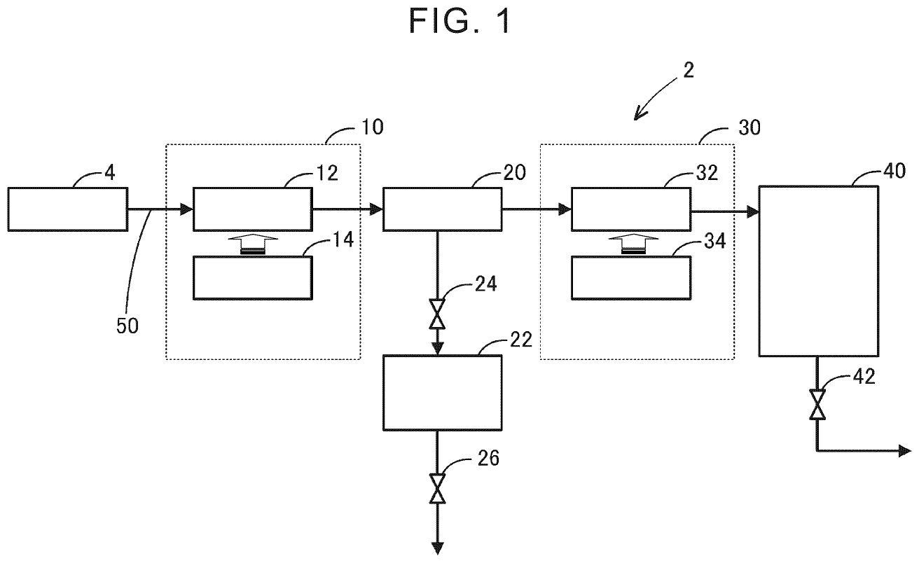

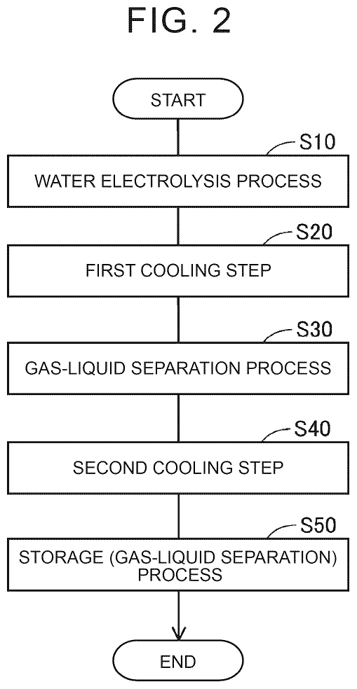

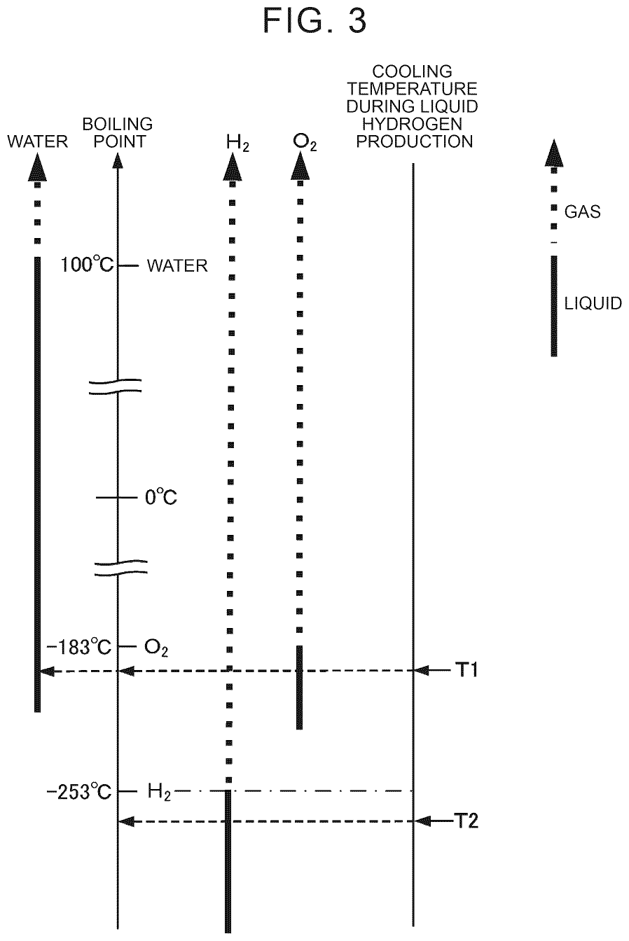

Hereinafter, the present system 2 and production method of a liquid material will be described with reference to the drawings as appropriate. FIG. 1 shows an example of the present system 2, FIG. 2 shows a process for producing a liquid material according to the present system, and FIG. 3 shows a relationship between an electrolytic gas and a cooling temperature during the production of liquid hydrogen. FIG. 1 to FIG. 3 illustrate a system and a process for producing liquid hydrogen by water electrolysis. Hydrogen is an example of a given gas component herein.

Note that the first and second cooling temperatures in the first cooling device and the second cooling device described in this specification are both temperatures at one atmospheric pressure. However, under a high pressure of more than 1 atmosphere or a reduced pressure of less than 1 atmosphere, the boiling point of the gas component such as hydrogen or oxygen is changed by the pressure, and accordingly, the first and second cooling temperatures are also changed.

The system 2 includes a water electrolysis device 4, a first cooling device 10, a gas-liquid separation device 20, a second cooling device 30, and a tank 40. The system 2 further comprises a conduit system 50 through which electrolysis gas or liquid can flow between these elements. Although not illustrated, the system 2 includes a first cooling device 10, a gas-liquid separation device 20, a second cooling device 30, and a sensor for detecting a temperature in the tank 40, and a control device for executing temperature control, and performs temperature control in these devices.

The water electrolysis device 4 is not particularly limited as long as hydrogen or oxygen can be produced by electrolysis of water. The water electrolysis device 4 may have a configuration known to those skilled in the art. As the water electrolysis device 4, for example, a water electrolysis device based on various forms such as alkali type water electrolysis, solid polymer type water electrolysis, and solid oxide type water electrolysis is used. Among them, an alkaline water electrolysis device and a water electrolysis device using a solid polymer water electrolysis device are used. The hydrogen produced by the water electrolysis device 4 can be supplied to the first cooling device 10.

The first cooling device 10 includes a heat exchanger 12 and a refrigerator 14. The heat exchanger 12 and the refrigerator 14 are not particularly limited, and known heat exchangers and refrigerators can be used, respectively. The gas cooled by the first cooling device 10 can be supplied to the gas-liquid separation device 20. The gas contains hydrogen as a main component, and may contain water and oxygen as impurities.

In the first cooling device 10, for example, as shown in FIG. 3, the supplied gases can be cooled to the first cooling temperature T1 at the time of production of liquid-hydrogen. Here, the first cooling temperature T1 is equal to or higher than the boiling point (−253° C.) of hydrogen. The first cooling temperature T1 is a temperature at which impurities having a boiling point higher than the first cooling temperature T1 (here, oxygen and water, which are impurities having a boiling point higher than hydrogen) can be liquefied. In the present embodiment, in order to separate oxygen as a liquid, the temperature is lower than the boiling point (−183° C.) of oxygen.

When the water-containing gas is cooled to the first cooling temperature T1, at least a part of the impurities having a boiling point higher than the first cooling temperature T1 is liquefied. As shown in FIG. 3, in the present embodiment, acid and water (boiling point: 100° C.) are used. The impurity liquefied by the first cooling temperature T1 is an exemplary first impurity herein. When water and oxygen are used as the first impurities, water and oxygen can be liquefied if the first cooling temperature T1 is higher than the boiling point of hydrogen and lower than the boiling point of oxygen. The first cooling temperature T1 is appropriately set in accordance with the boiling point of the constituent gases, the cooling efficiency, the cost, and the boiling point of the impurities to be separated.

The gas-liquid separation device 20 separates the liquid in the gas supplied from the first cooling device 10. Specifically, the gas-liquid separation device 20 separates water and oxygen, which are impurities as a liquid, from a gas containing gaseous hydrogen and impurities liquefied by the first cooling device. Further, the gas from which the impurity liquid has been separated in the gas-liquid separation device 20 is supplied to the second cooling device 30. The gas-liquid separation device 20 can be appropriately selected and used from known gas-liquid separation devices.

The impurity liquid separated in the gas-liquid separation device 20 is stored in the temporary storage tank 22. The impurity liquid in the temporary storage tank 22 closes the valve 24, opens the valve 26, and is discharged to the outside of the system 2.

The second cooling device 30 includes a heat exchanger 32 and a refrigerator 34. The heat exchanger 32 and the refrigerator 34 are not particularly limited, and known heat exchangers and refrigerators can be used, respectively. The gas cooled by the second cooling device 30 can be supplied to the tank 40.

In the second cooling device 30, for example, as shown in FIG. 3, the supplied gases can be cooled to the second cooling temperature T2 at the time of production of liquid-hydrogen. The second cooling temperature T2 is a temperature lower than the first cooling temperature T1 and lower than the boiling point (−253° C.) of hydrogen. The second cooling temperature is a temperature at which a second impurity having a boiling point lower than the second cooling temperature T2 (here, an impurity having a boiling point lower than that of hydrogen is left as a gas). Since the freezing point of hydrogen is −259° C., it may be preferable that the freezing point of hydrogen is higher than −259° C. while avoiding the freezing of hydrogen.

By cooling to the second cooling temperature T2, hydrogen is liquefied or solidified from the gaseous state. At least some of the impurities having a boiling point lower than the second cooling temperature T2 remain as gases. For example, helium (−269° C.). Impurities remaining as gases also due to the second cooling temperature T2 are exemplary of the second impurities herein. At least a portion of the second impurity is contained in the liquid hydrogen in a gaseous state. Note that the second cooling temperature T2 is a temperature equal to or higher than the boiling point of an impurity to be left as a gas. The second cooling temperature T2 is appropriately set in accordance with the boiling point of the constituent gases, the cooling efficiency, the cost, the boiling point of the impurities to be separated, and the like.

The tank 40 stores the cooled liquid from the second cooling device 30. The tank 40 is configured, for example, to be able to hold the fluid at a second cooling temperature T2. In this way, impurities remaining as a gas state are stored together with the liquid hydrogen by the second cooling device 30 in the tank 40. Further, in the tank 40, the second impurity is separated from the liquid hydrogen by gas-liquid separation. The liquid hydrogen from which the impurities are separated as a gas is supplied to the hydrogen utilization destination by opening the valve 42. The tank 40 also functions as a gas-liquid separation device for gasifying impurities as well as storage of liquid hydrogen.

The system 2 may include a gasifier for gasifying a liquid material such as liquid hydrogen.

Next, with reference to FIGS. 2 and 3, a process of producing liquid hydrogen as an example of a liquid material by electrolysis of water using the present system 2 will be described.

As shown in FIG. 2, in the water electrolysis process S10, water is electrolyzed in the water electrolysis device 4. The hydrogen gas generated by the electrolysis is supplied to the first cooling device 10.

In the first cooling step S20, the supplied hydrogen-gas is cooled to the first cooling temperature T1. By cooling to the first cooling temperature T1, at least a part of water and oxygen contained in the hydrogen gas is liquefied as shown in FIG. 3. The gas cooled by the first cooling device 10 is supplied to the gas-liquid separation device 20.

In the gas-liquid separation step S30, at least a portion of water and oxygen are separated from the liquefied hydrogen gas as a liquid. The liquid is stored in the temporary storage tank 22 and discharged to the outside of the system 2 in a timely manner. The hydrogen gas from which the liquid has been separated is supplied from the gas-liquid separation device 20 to the second cooling device 30.

In the second cooling step S40, the hydrogen gas supplied to the second cooling device 30 is cooled to the second cooling temperature T2. The second cooling temperature T2 is a temperature lower than the boiling point (−253° C.) of hydrogen. By being cooled to the second cooling temperature T2, the hydrogen-gas is liquefied as shown in FIG. 3. In addition, at least some of the impurities having a boiling point lower than the second cooling temperature T2 remain gaseous and are contained in the liquid-hydrogen. The liquid hydrogen is supplied from the second cooling device 30 to the tank 40.

In the storage step S50, the liquid-hydrogen gas supplied to the tank 40 is stored while the second cooling temperature T2 is maintained. While being stored in the tank 40, the gas, which is an impurity, is separated from the liquid hydrogen. Such an impurity-containing gas is stored as a gas phase in a headspace or the like of the tank 40.

The liquid phase part of the tank 40 removes impurities (water and oxygen) having a boiling point higher than the first cooling temperature T1 and impurities having a boiling point lower than the second cooling temperature, so that the liquid hydrogen is higher in purity and contains hydrogen. The liquid hydrogen is supplied to a user (a use place) outside the system 2 by opening the valve 42. The liquid hydrogen may be gasified by a gasifier that may be provided in the system 2, or may be gasified by a supply destination.

Note that by discharging a part of the gas phase of the tank 40 to the outside of the present system 2 and increasing the internal pressure by evaporation of the gas from the liquid hydrogen, the impurity concentration in the gas phase and thus the liquid phase can be further reduced.

In the above description, the production of liquid hydrogen or hydrogen gas by electrolysis of water has been described, but the present system 2 can also be used as it is to produce liquid oxygen or oxygen gas, which is also an example of a liquid material, from the water electrolysis device 4. That is, the first cooling device 10, the gas-liquid separation device 20, the second cooling device 30, and the tank 40 of the present system 2 can be applied to the production of liquid oxygen or oxygen gas. The system 2 may further include a first cooling device, a gas-liquid separation device, a second cooling device, a tank, and a pipeline system for liquid oxygen and the like.

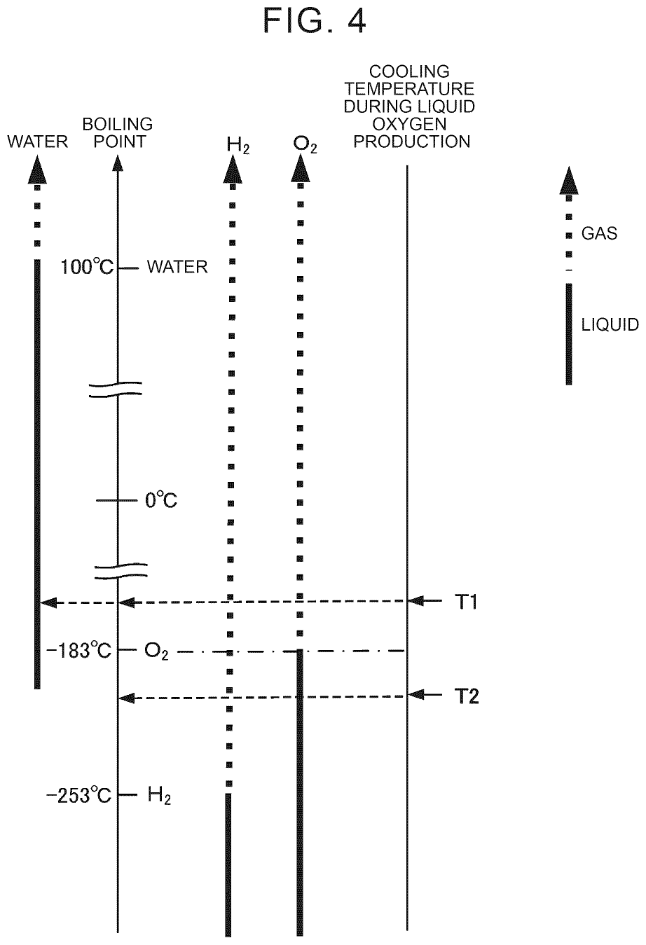

The production of the oxygen gas using the present system 2 can be carried out in the same manner as the production of the hydrogen gas described above except for the first cooling temperature in the first cooling device and the second cooling temperature in the second cooling device. Hereinafter, with reference to FIG. 4, the first cooling temperature in the first cooling device, the second cooling temperature in the second cooling device, and the like at the time of manufacturing the oxygen gas will be described. Note that the oxygen gas produced by the water electrolysis device 4 contains oxygen as a main component and may contain water and hydrogen as impurities.

As shown in FIG. 4, in the case of oxygen gas, the first cooling temperature is a temperature equal to or higher than the boiling point (−183° C.) of oxygen. Cooling to the first cooling temperature T1 liquefies at least a portion of the impurities having a boiling point higher than the first cooling temperature T1. For example, water (boiling point 100° C.). The first cooling temperature T1 is capable of liquefying water at a temperature higher than the boiling point of oxygen. Here, hydrogen as an impurity is in a gas state together with oxygen. The first cooling temperature T1 is a temperature lower than the boiling point (100° C.) of water.

As shown in FIG. 4, the second cooling temperature T2 is a temperature lower than the first cooling temperature T1 and lower than the boiling point (−183° C.) of oxygen. The second cooling temperature T2 is a temperature equal to or higher than the boiling point of hydrogen. By being cooled to the second cooling temperature T2, oxygen is liquefied. In addition, at least a part of impurities having a boiling point lower than the second cooling temperature T2 remains as gases. Such impurities are, for example, hydrogen (−253° C.). At least a part of the impurities is contained in the oxygen liquefied in the gas state.

The liquid-oxygen cooled to the second cooling temperature T2 is stored in the tank 40 at the second cooling temperature T2. In the tank 40, impurities such as hydrogen are separated into gas phases from the liquid oxygen by gas-liquid separation. The separated liquid oxygen is supplied to the utilization destination as appropriate. In addition, the liquid oxygen is appropriately gasified.

As described above, the present system 2 and the production method of a gas by electrolysis of water are also applicable to the production of liquid oxygen and oxygen gas.

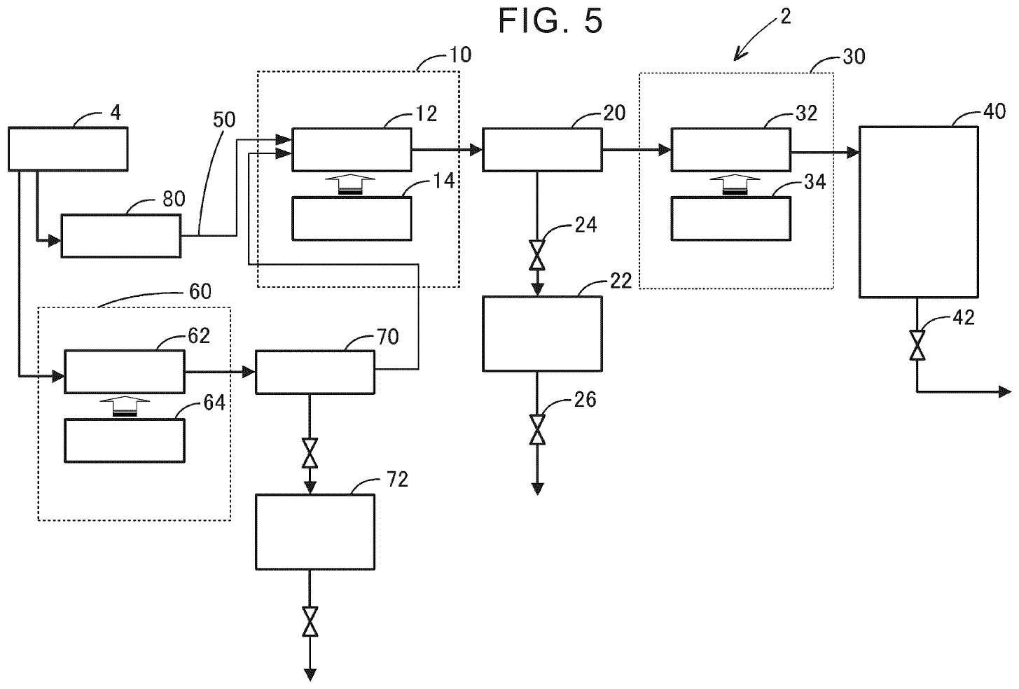

In the above description, the system 2 includes the first cooling device 10, the gas-liquid separation device 20, and the second cooling device 30, but the present disclosure is not limited thereto. For example, as shown in FIG. 5, an additional cooling device 60, a gas-liquid separation device 70, and a temporary storage tank 72 may be provided. By setting an additional cooling temperature in the additional cooling device 60, for example, when impurities other than water, oxygen, and hydrogen can be included, the plurality of impurities can be separated as a liquid or a gas. The additional cooling device 60 may comprise a heat exchanger 62 and a refrigerator 64.

For example, as shown in FIG. 5, an impurity separation device 80 made of an adsorbent material that adsorbs impurities such as water, such as a conventional dehumidifier, may be provided.

While several specific examples have been described in detail above, these are merely illustrative and do not limit the scope of the claims. The technique described in the claims includes various modifications and variations of the specific examples exemplified above. The technical elements described in this specification or in the drawings may be used alone or in combination to achieve technical usefulness.

What is claimed is:

1. A water electrolysis system comprising:
a first cooling device that cools a gas containing a predetermined gas component, generated by electrolysis of water, to a first cooling temperature that is no lower than a boiling point of the gas component, and separably liquifies a first impurity of which a boiling point is higher than the first cooling temperature, as a liquid;
a gas-liquid separation device that separates the first impurity liquefied by the first cooling device from the gas; and
a second cooling device that cools the gas from which the first impurity is separated to a second cooling temperature that is lower than the boiling point of the gas component, and liquifies the gas component such that a second impurity, of which a boiling point is lower than the second cooling temperature, is separable as a gas.

2. The water electrolysis system according to claim 1, wherein the gas component is hydrogen or oxygen.

3. The water electrolysis system according to claim 2, wherein:
the gas component is hydrogen; and
the first cooling temperature is a temperature that is no lower than the boiling point of hydrogen and lower than the boiling point of oxygen, and the second cooling temperature is a temperature that is lower than the boiling point of hydrogen.

4. The water electrolysis system according to claim 2, wherein:
the gas component is oxygen; and
the first cooling temperature is a temperature that is no lower than the boiling point of oxygen, and the second cooling temperature is a temperature that is lower than the boiling point of oxygen and no lower than the boiling point of hydrogen.

5. The water electrolysis system according to claim 1, wherein:
the first cooling device includes a first heat exchanger and a cooler for cooling the first heat exchanger; and
the second cooling device includes a second heat exchanger and a cooler for cooling the second heat exchanger.

6. A production method of a liquid material by electrolysis of water, the production method comprising:
first cooling, of cooling a gas obtained by electrolysis of water supplied from an electrolysis device, and that contains the liquid material that is gasified, to a first cooling temperature that is no lower than a boiling point of the liquid material, and separably liquifying a first impurity of which a boiling point is higher than the first cooling temperature, as a liquid;
performing gas-liquid separation of the first impurity from the gas; and
second cooling, of cooling the gas from which the first impurity is separated to a second cooling temperature that is lower than the boiling point of the liquid material, and liquifying the liquid material that is gasified such that a second impurity, of which a boiling point is lower than the second cooling temperature, is separable as a gas.
